(19) United States
(12) Patent Application Publication
(10) Pub. No.: US 2007/0180282 A1
(43) Pub. Date: Aug. 2, 2007

(54) Power-saving control apparatus and method for a portable computer

(75) Inventor: Yang Hoon Kim, Seongnam City (KR)

Correspondence Address: KED & ASSOCIATES, LLP, P.O. Box 221200, Chantilly, VA, 20153-1200, US

(73) Assignee: LG Electronics Inc.

(21) Appl. No.: 11/526,797

(22) Filed: Sep. 26, 2006

(30) Foreign Application Priority Data
Feb. 2, 2006 (KR) 2006-0010277

(51) Int. Cl. G06F 1/32

(52) U.S. Cl. 713/320

(57) ABSTRACT

A power-saving control apparatus and method are provided for a portable computer to save power by lowering a speed of a central processing unit (CPU) when a lid of the portable computer is closed. A lid switch input circuit may generate a switch-on signal when the lid of the portable computer is closed so that a lid switch is on, and the lid switch input unit may generate a switch-off signal when the lid of the portable computer is opened so that the lid switch is off.

The present application claims priority from Korean Application No. 10277/2006, filed Feb. 2, 2006, the subject matter of which is incorporated herein by reference.

### BACKGROUND

1. Field

Embodiments of the present invention may relate to a power-saving control apparatus and method for a portable computer that performs control for saving power when a lid of the portable computer is closed. More particularly, embodiments of the present invention may relate to a power-saving control apparatus and method for a portable computer that saves power by lowering a speed of a central processing unit (CPU) when a lid of the portable computer is closed.

2. Background

A user may designate an operation to be performed when a lid of a portable computer is closed as one of three modes illustrated in FIG. 1 through an input window provided by a Windows program, for example, so that a desired operation can be performed when a lid of a portable computer is closed.

The three modes shown in FIG. 1 include a “standby mode,” a “maximum power-saving mode” and an “idle mode.” When a user designates the “standby mode” or the “maximum power-saving mode,” a preparatory period after the lid of the portable computer is closed and then re-opened may be as long as a computer booting period when the portable computer is turned off and is then turned on. This may cause inconvenience to the user.

On the other hand, when the user designates the “idle mode,” the computer system may not perform any operation when the lid of the portable computer is closed. In this case, the preparatory period may be short but power may be unnecessarily consumed.

A portable computer system may support three operating modes, namely a “maximum performance mode” in which a central processing unit (CPU) operates at a maximum speed, an “automatic mode” in which a CPU operates at a speed proportional to a system load, and an “optimum battery mode” in which a CPU operates at a speed lower than half of the maximum speed of the CPU. When the CPU is in the “maximum performance mode,” the portable computer may consume more power when the lid of the portable computer is closed. The speed of a CPU is proportional to the frequency of a clock signal applied to the CPU and is closely related to power consumption.

### BRIEF DESCRIPTION OF THE DRAWINGS

Features and advantages of embodiments of the present invention may become apparent from the following description taken in conjunction with the accompanying drawings, in which like elements refer to like elements and wherein:

FIG. 1 is a view illustrating an input window for designating an operation to be performed when a lid of a portable computer is closed;

FIG. 2 is a block diagram illustrating a configuration of a power-saving control apparatus for a portable computer according to an example embodiment of the present invention;

FIG. 3 is a view illustrating an input window for designating an operation to be performed when a lid of a portable computer is closed according to an example embodiment of the present invention; and

FIG. 4 is a flowchart illustrating a power-saving control method for a portable computer according to an example embodiment of the present invention.

### DETAILED DESCRIPTION

A power-saving control apparatus and method for a portable computer will be described with reference to the accompanying drawings. The following discussion may also relate to external devices that may be connected to (or coupled to) a portable computer. Examples of external devices may include, but are not limited to: a projector, an external monitor, and/or a camcorder that can be used by being connected to a portable computer. For ease of illustration, a description will be made in connection with the external monitor.

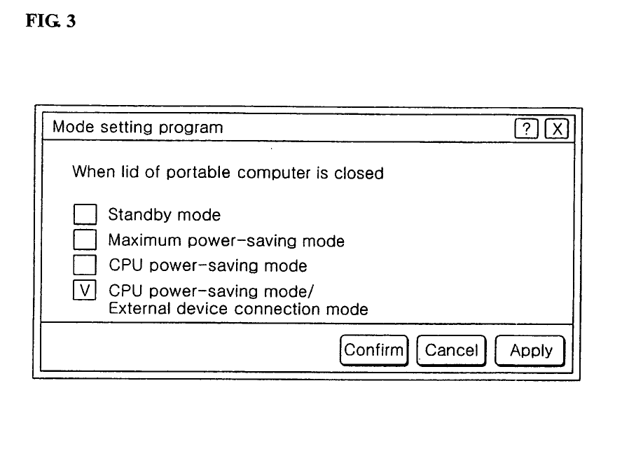

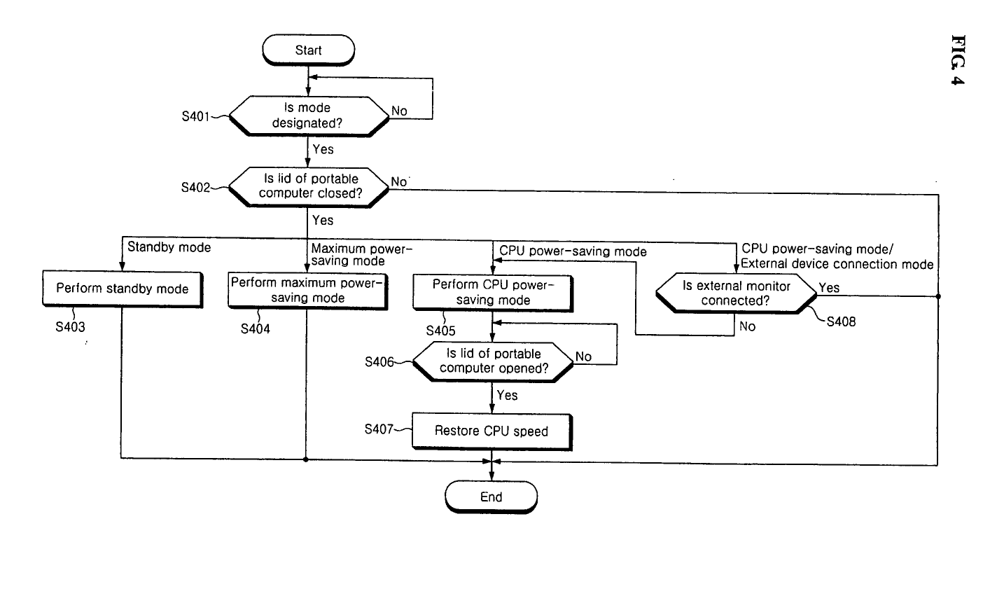

FIG. 2 is a block diagram illustrating a configuration of a power-saving control apparatus for a portable computer according to an example embodiment of the present invention. FIG. 3 is a view illustrating an input window for designating an operation to be performed when a lid of a portable computer is closed according to an example embodiment of the present invention. Other configurations and embodiments are also within the scope of the present invention.

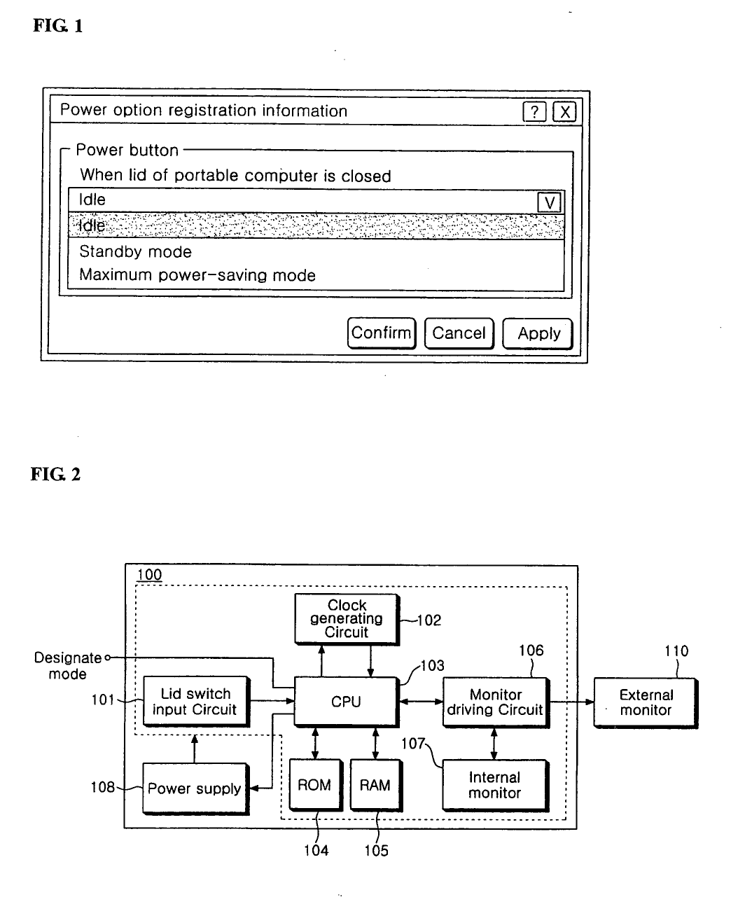

The four-mode input window shown in FIG. 3 may be implemented by an application program cooperating with a Windows program by which the input window of FIG. 1 is implemented. In an example embodiment, a “CPU power-saving mode” and an “external device connection mode” are provided rather than an “idle” mode that may cause unnecessary power consumption.

As shown in FIG. 2, in a portable computer 100, a lid switch input circuit (or unit) 101 may generate a switch-on signal when a lid of the portable computer is closed and therefore a lid switch is on. The lid switch input circuit 101 may generate a switch-off signal when the lid of the portable computer is open and thus the lid switch is off.

The lid switch may include a pair of switch components provided at centers (or approximate centers) of an upper portion (i.e., a monitor portion) and a lower portion (i.e., a keyboard portion) of the portable computer, and the lid switch may be on or off when the lid of the portable computer is closed or opened, respectively. The lid switch and/or switch components may be provided at other locations.

A clock-generating circuit (or unit) 102 may generate a clock signal having a predetermined frequency (or an operating frequency). The frequency of the clock signal may be adjusted higher or lower by a control signal from a CPU 103 (or other processor).

A read only memory (ROM) 104 may store various kinds of operating programs and application programs. A RAM 105 may temporarily store programs to be executed, which are loaded from the ROM 104 by the CPU 103.

A monitor-driving circuit (or unit) 106 may apply a driving signal to an internal monitor 107 (or an external monitor 110) under control of the CPU 103.

When a user presses a power button (not shown), a power supply 108 may supply power to components of the portable computer or cut off the supply of power to relevant components under control of the CPU 103.

The CPU 103 may drive and control the respective components of the portable computer 100 in synchronization with the clock signal generated by the clock-generating circuit 102.

When the user designates an operation to be performed “when a lid of a portable computer is closed” and the lid switch input unit 101 generates the switch-on signal (when the lid of the portable computer is closed), the CPU 103 may perform control such that an operation corresponding to the mode designated by the user is carried out. These different modes will now be explained.

1. Designate “Standby Mode” or “Maximum Power-Saving Mode”

When a user desiring to operate a portable computer designates the “standby mode” or the “maximum power-saving mode” through the input window shown in FIG. 3, the closing of the lid generates a switch-on signal. The CPU 103 may store a pending program in the RAM 105 and control the power supply 108 such that the supply of power to all components except the RAM 105 (and the CPU 103 in the “standby mode”) is cut off.

In the maximum power-saving mode (or other power-saving mode), all power supplied to the RAM 105 and the CPU 103 may be cut off when the lid of the portable computer is closed. On the other hand, in the standby mode, power supplied to the RAM 105 may be maintained and the power supplied to the CPU 103 is cut off. Accordingly, power consumption may be further reduced in the “maximum power-saving mode” as compared with the “standby mode.” However, since both modes are similar in that the CPU is driven when the lid of the portable computer is re-opened, there may be no difference (or little difference) between the two modes in view of the increase in the preparatory period for use of the portable computer. Although the above description describes all power being cut off (or turned off), other types of modes may reduce power without fully turning off the power.

Thereafter, when the lid of the portable computer is opened and a switch-off signal is generated, the CPU 103 may control the power supply 108 to re-supply power to the respective components and again execute the program stored in the RAM 105. This may increase the preparatory period to resume a task.

2. Designate “CPU Power-Saving Mode”

When the user designates the “CPU power-saving mode” (or other power-saving mode) through the input window shown in FIG. 3 and the closing of the lid causes generation of a switch-on signal, the CPU 103 may control the clock-generating circuit 102 so as to lower the frequency of a clock signal below half of a maximum frequency of the CPU. Accordingly, the preparatory period required upon closing and subsequent re-opening of the lid of the portable computer is not long and power consumption may be minimized (or decreased) when the lid of the portable computer is closed. While the above description discusses a frequency below half of a maximum frequency of the CPU, other frequencies may also be used.

3. Designate “External Device Connection Mode”

When the user designates the “external device connection mode” through the input window shown in FIG. 3 and the closing of the lid causes generation of a switch-on signal, the CPU 103 may determine whether the external monitor 110 (or other external device) is connected to the portable computer via the monitor-driving circuit 106. When the external monitor 110 (or other external device) is not connected thereto, the CPU 103 may control the clock-generating circuit 102 to lower the frequency of a clock signal below half of the maximum frequency of the CPU. This may shorten the preparatory period required upon closing and subsequent re-opening of the lid of the portable computer and may minimize (or reduce) the power consumption when the lid of the portable computer is closed. While the above description discusses a frequency below half of a maximum frequency of the CPU, other frequencies may also be used.

The external device connection mode may allow the user to perform a task at a normal speed using the external monitor 110 (or other external device) even in a state where the lid of the portable computer is closed and the internal monitor 107 is not used when the external monitor 110 is connected to the portable computer.

In a state where the user designates the “CPU power-saving mode” or the “external device connection mode” and the frequency of a clock signal is set to be lowered by the CPU 103 in order to minimize (or reduce) power consumption, the CPU 103 may control the clock-generating circuit 102 so as to restore the frequency of the clock signal to an original frequency (or another frequency such as a predetermined frequency or operating frequency) when the lid of the portable computer is opened and a switch-off signal is generated by the lid switch input circuit 101.

FIG. 4 is a flowchart illustrating a power-saving control method for a portable computer according to an example embodiment of the present invention. Other operations, orders of operations and embodiments are also within the scope of the present invention. Other operations, orders of operations and embodiments are also within the scope of the present invention.

When a user designates an operation to be performed upon closing a lid of a portable computer through the input window shown in FIG. 3 (Yes in S401), the CPU 103 determines whether the lid of the portable computer is closed (S402).

When it is determined in step S402 that the lid of the portable computer is closed and accordingly a switch-on signal is generated by the lid switch input circuit 101 (Yes in S402), the CPU 103 performs control such that an operation corresponding to the mode designated by the user in operation S401 is carried out.

An operation or operations corresponding to each mode designated by the user will now be described in detail.

When the “standby mode” or the “maximum power-saving mode” is designated by the user in operation S401, the CPU 103 may perform control such that an operation corresponding to the “standby mode” or the “maximum power-saving mode” is carried out by storing a pending program in the RAM 105. For example, the CPU 103 may control the power supply 108 to cut off (or reduce) power to components except the RAM 105 (and the CPU 103 in the “standby mode”) (S403 and S404).

When the “CPU power-saving mode” is designated by the user in operation S401, the CPU 103 may perform control such that an operation corresponding to the “CPU power-saving mode” is carried out by controlling the clock-generating circuit 102 to lower the frequency of the clock signal to below half of the maximum frequency of the CPU (S405). When it is determined from generation of a switch-off signal by the lid switch input circuit 101 that the lid of the portable computer is opened (Yes in S406), the CPU 103 controls the clock-generating circuit 102 to restore the frequency of the clock signal to an original (or predetermined) frequency, thereby restoring an original (or predetermined) CPU speed (S407). As an alternative to restoring the frequency to an original frequency, the CPU 103 may control the clock-generating circuit 102 to an operating frequency.

On the other hand, when the “external device connection mode” is designated by the user in operation S401, the CPU 103 may determine whether the external monitor 110 (or other external device) is connected via the monitor-driving circuit 106. When the external monitor 110 is not connected (No in S408), the CPU 103 may perform control such that the operation corresponding to the “CPU power-saving mode” is carried out by controlling the clock-generating circuit 102 to lower the frequency of the clock signal below half of the maximum frequency of the CPU 103 (S405). When the external monitor 110 is connected via the monitor-driving circuit 106 (Yes in S408), the CPU 103 may terminate the procedure without performing control such that operation of S405 corresponding to the “CPU power-saving mode” is carried out by lowering the CPU speed to minimize power consumption.

In the power-saving control apparatus and method for a portable computer according to example embodiments, the speed of a CPU may be lowered when a lid of a portable computer is closed, thereby minimizing or reducing unnecessary power consumption and improving economical efficiency while also preventing an increase in a preparatory period required upon closing and subsequent re-opening of the lid of the portable computer.

Embodiments of the present invention may provide a power-saving control apparatus and method for a portable computer that performs control for lowering a speed of a CPU in a state where a lid of the portable computer is closed, thereby minimizing unnecessary power consumption while preventing an increase in a preparatory period when the lid of the portable computer is closed and then re-opened.

Embodiments of the present invention may provide a power-saving control apparatus for a portable computer that includes a clock signal generating circuit (or unit) for generating a clock signal with a predetermined frequency; a lid switch input circuit (or unit) for generating a switch-on signal when a lid of the portable computer is closed so that a lid switch is on; and a control circuit (or unit) for driving and controlling respective components of the portable computer in synchronization with the generated clock signal, and controlling the clock signal generating circuit to lower the frequency of the clock signal when the switch-on signal is generated.

The lid switch input circuit may generate a switch-off signal when the lid of the portable computer is opened so that the lid switch is off, and the control circuit may control the clock signal generating circuit to restore the frequency of the clock signal to an original frequency when the switch-off signal is generated.

The control circuit may control the clock signal generating circuit to lower the frequency of the clock signal below half of a maximum frequency when the switch-on signal is generated.

If a central processing unit (CPU) power-saving mode is designated, the control circuit may perform a control operation corresponding to the generation of the switch-on signal or the switch-off signal.

If the CPU power-saving mode is designated and an external device is not connected to the portable computer, the control circuit may perform a control operation corresponding to the generation of the switch-on signal or the switch-off signal.

The mode may be a maximum power-saving mode (or power-saving mode) in which power to a CPU and a random access memory (RAM) is cut off, a standby mode in which power to the CPU is cut off, or a CPU power-saving mode in which power is supplied to the CPU and the clock signal generating circuit is controlled to lower the frequency of the clock signal when the lid switch is on.

The mode may also be an external device connection mode in which the clock signal generating circuit is controlled to maintain the frequency of the clock signal if an external device is connected to the portable computer during execution of the CPU power-saving mode.

Embodiments of the present invention may also provide a power-saving control method for a portable computer. This may include driving and controlling respective components of the portable computer in synchronization with a clock signal with a predetermined frequency, checking (or determining) whether a lid of the portable computer is closed, and if it is checked (or determined) that the lid of the portable computer is closed, performing control such that the frequency of the clock signal is lowered.

The method may further include checking (or determining) whether the lid of the portable computer is opened, and if it is checked (or determined) that the lid of the portable computer is opened, performing control such that the frequency of the clock signal is restored to an original frequency.

Lowering the frequency may include performing control such that the frequency of the clock signal is lowered below half of a maximum frequency (or other frequency).

Lowering the frequency may include performing the control operation corresponding to the closing of the lid of the portable computer if a central processing unit (CPU) power-saving mode is designated.

Lowering the frequency may include performing the control operation corresponding to the closing of the lid of the portable computer if the CPU power-saving mode is designated and an external device is not connected to the portable computer.

Restoring the frequency may include performing the control operation corresponding to the opening of the lid of the portable computer if a CPU power-saving mode is designated.

Restoring the frequency may include performing the control operation corresponding to the opening of the lid of the portable computer if the CPU power-saving mode is designated and an external device is not connected to the portable computer.

Lowering the frequency or restoring the frequency may include performing the control operation corresponding to the opening or closing of the lid of the portable computer if a CPU power-saving mode is designated.

Lowering the frequency or restoring the frequency may include performing the control operation corresponding to the opening or closing of the lid of the portable computer if the CPU power-saving mode is designated and an external device is not connected to the portable computer.

Embodiments of the present invention may also provide a power-saving controlling method for a portable computer that includes checking (or determining) whether a lid of the portable computer is closed, detecting a set mode, and if the lid of the portable computer is closed, performing the detected, set mode. The set mode may be a maximum power-saving mode (or a power-saving mode) in which power to a CPU and a RAM is cut off, a standby mode in which power to a CPU is cut off, or a CPU power-saving mode in which power is supplied to the CPU and a clock signal generating circuit is controlled to lower the frequency of a clock signal.

The set mode may further be an external device connection mode in which the clock signal generating circuit is controlled to maintain the frequency of the clock signal if an external device is connected to the portable computer during execution of the CPU power-saving mode.

In the power-saving control apparatus and method for a portable computer, in order to minimize (or decrease) unnecessary power consumption while preventing an increase in a preparatory period upon closing and subsequent re-opening of the lid of the portable computer, the speed of a CPU may be controlled to be lowered when the lid of the portable computer is closed, the speed of the CPU may be controlled to be lowered only when the CPU power-saving mode is designated by a user, and the speed of the CPU may be lowered only when an external device is not connected to the portable computer even though the CPU power-saving mode is designated by the user.

Any reference in this specification to “one embodiment,” “an embodiment,” “example embodiment,” etc., means that a particular feature, structure, or characteristic described in connection with the embodiment is included in at least one embodiment of the present invention. The appearances of such phrases in various places in the specification are not necessarily all referring to the same embodiment. Further, when a particular feature, structure, or characteristic is described in connection with any embodiment, it is submitted that it is within the purview of one skilled in the art to affect such feature, structure, or characteristic in connection with other ones of the embodiments.

Although embodiments of the present invention have been described with reference to a number of illustrative embodiments thereof, it should be understood that numerous other modifications and embodiments can be devised by those skilled in the art that will fall within the spirit and scope of the principles of this invention. More particularly, reasonable variations and modifications are possible in the component parts and/or arrangements of the subject combination arrangement within the scope of the foregoing disclosure, the drawings and the appended claims without departing from the spirit of the invention. In addition to variations and modifications in the component parts and/or arrangements, alternative uses will also be apparent to those skilled in the art.

What is claimed is:

1. A power-saving control apparatus for a portable computer, comprising:
a clock signal generating circuit for generating a clock signal with a first frequency;
a lid switch input circuit for generating a switch-on signal when a lid of the portable computer is closed and a lid switch is on; and
a control circuit for controlling components of the portable computer based on the generated clock signal, and the control circuit controlling the clock signal generating circuit to lower the frequency of the clock signal to a second frequency when the switch-on signal is generated.

2. The apparatus as claimed in claim 1, wherein the lid switch input circuit generates a switch-off signal when the lid of the portable computer is opened and the lid switch is off, and
the control circuit controls the clock signal generating circuit to restore the frequency of the clock signal to the first frequency when the switch-off signal is generated.

3. The apparatus as claimed in claim 2, wherein when a central processing unit (CPU) power-saving mode is designated, the control circuit performs a control operation corresponding to the generation of the switch-on signal or the switch-off signal.

4. The apparatus as claimed in claim 3, wherein when the CPU power-saving mode is designated and an external device is not connected to the portable computer, the control circuit performs a control operation corresponding to the generation of the switch-on signal or the switch-off signal.

5. The apparatus as claimed in claim 1, wherein the control circuit controls the clock signal generating circuit to lower the frequency of the clock signal to the second frequency based on a mode set by a user.

6. The apparatus as claimed in claim 1, wherein the control circuit controls the clock signal generating circuit to lower the frequency of the clock signal below half of a maximum frequency of a processor when the switch-on signal is generated.

7. A power-saving control apparatus for a portable computer, comprising:
a clock signal generating circuit for generating a clock signal with a predetermined frequency;
a lid switch input circuit for generating a switch-on signal when a lid of the portable computer is closed; and
a control circuit for controlling components of the portable computer based on the generated clock signal and based on a set mode, wherein the set mode is a CPU power-saving mode in which power is supplied to the CPU and a clock signal generating circuit lowers the frequency of the clock signal based on the generated switch-on signal.

8. The apparatus as claimed in claim 7, wherein the control circuit additionally controls components based on further set modes, the further set modes including a power saving mode in which power to the CPU and a random access memory (RAM) is reduced when the lid is closed, and a standby mode in which power to the CPU is cut off.

9. The apparatus as claimed in claim 8, wherein the set modes further include an external device connection mode in which the control circuit controls the clock signal generating circuit to maintain the frequency of the clock signal when an external device is connected to the portable computer during execution of the CPU power-saving mode.

10. A power-saving control method for a portable computer, the method comprising:
(a) controlling components of the portable computer based on a clock signal having a first frequency;
(b) determining whether a lid of the portable computer is closed or whether the lid is opened; and
(c) when it is determined that the lid of the portable computer is closed, decreasing the frequency of the clock signal to a second frequency.

11. The method as claimed in claim 10, wherein decreasing the frequency of the clock signal includes lowering the frequency of the clock signal to below half of a maximum frequency of a processor.

12. The method as claimed in claim 10, wherein decreasing the frequency of the clock signal occurs when a central processing unit (CPU) power-saving mode is designated.

13. The method as claimed in claim 12, wherein decreasing the frequency of the clock signal occurs when the CPU power-saving mode is designated and an external device is not connected to the portable computer.

14. The method as claimed in claim 10, further comprising:
(d) when it is determined that the lid of the portable computer is opened, changing the frequency of the clock signal from the second frequency.

15. The method as claimed in claim 14, wherein changing the frequency of the clock signal occurs when a CPU power-saving mode is designated.

16. The method as claimed in claim 15, wherein changing the frequency of the clock signal occurs when the CPU power-saving mode is designated and an external device is not connected to the portable computer.

17. A power-saving control method for a portable computer, the method comprising:
(a) determining whether a lid of the portable computer is closed;
(b) detecting a set mode; and
(c) when the lid of the portable computer is closed, performing the set mode, wherein the set mode includes a first power-saving mode in which power is supplied to components of the personal computer and a frequency of a clock signal is lowered by a clock signal generating circuit.

18. The method as claimed in claim 17, further comprising performing another set mode, the another set mode including one of a second power-saving mode in which power to a processor and a memory is reduced or a standby mode in which power to the processor is cut off.

19. The method as claimed in claim 18, wherein the another set mode further includes an external device connection mode in which the clock signal generating circuit maintains the frequency of the clock signal if an external device is connected to the portable computer during execution of the first power-saving mode.

20. A power saving control apparatus comprising:
a clock signal circuit to generate a clock signal having a first frequency;
a switch device to determine whether a computer is closed or open; and
a control circuit to supply the generated clock signal to components of the computer, the control signal to change the clock signal to a second frequency based on whether the switch device determines the computer to be closed or to be open.

21. The apparatus as claimed in claim 20, wherein the second frequency is lower than the first frequency.

22. The apparatus as claimed in claim 20, wherein the second frequency is less than half of an operating frequency of the computer.

23. The apparatus as claimed in claim 20, wherein when a central processing unit (CPU) power-saving mode is designated, the control circuit performs a control operation corresponding to the generation of the switch-on signal or the switch-off signal.

24. The apparatus as claimed in claim 20, wherein when the CPU power-saving mode is designated and an external device is not connected to the portable computer, the control circuit performs a control operation corresponding to the generation of the switch-on signal or the switch-off signal.
